(19) United States
(12) Patent Application Publication
(10) Pub. No.: US 2023/0373066 A1
(43) Pub. Date: Nov. 23, 2023

(54) TOOL BIT

(71) Applicant: MILWAUKEE ELECTRIC TOOL CORPORATION, Brookfield, WI (US)

(72) Inventor: John J. Springer, Milwaukee, WI (US)

(21) Appl. No.: 18/248,829

(22) PCT Filed: Oct. 20, 2021
(86) PCT No.: PCT/US2021/055710

§ 371 Date: Apr. 12, 2023

Related U.S. Application Data
(60) Provisional application No. 63/094,595, filed on Oct. 21, 2020.

(51) Int. Cl. B25B 15/00

(52) U.S. Cl. CPC B25B 15/005

(57) ABSTRACT

A tool bit including a working end configured to engage a work surface, a shank extending from the working end and defining a longitudinal axis, and a drive portion coupled to an end of the shank opposite from the working end, the drive portion including a plurality of corners, the drive portion including a plurality of corners, the drive portion being configured to be engaged by a tool, wherein the drive portion includes a plurality of grooves formed at the plurality of corners and circumferentially spaced around the longitudinal axis.

### CROSS-REFERENCE TO RELATED APPLICATIONS

This application claims priority to U.S. Provisional Application No. 63/094,595, filed on Oct. 21, 2020, and entitled “Tool Bit”, the contents of which are hereby incorporated by reference in their entirety.

### FIELD OF THE INVENTION

The present invention relates to tool bits, and more particularly to a drive portion of a tool bit.

### SUMMARY

In one aspect, the invention provides a tool bit including a working end configured to engage a work surface, a shank extending from the working end and defining a longitudinal axis, and a drive portion coupled to an end of the shank opposite from the working end, the drive portion including a plurality of corners, the drive portion being configured to be engaged by a tool, wherein the drive portion includes a plurality of grooves formed at the plurality of corners and circumferentially spaced around the longitudinal axis.

In another independent aspect, the invention provides a tool bit including a working end, a shank extending from the working end and defining a longitudinal axis, and a drive portion coupled to an end of the shank opposite form the working end, the drive portion including a plurality of corners, the drive portion being configured to be engaged by a tool. The drive portion includes a plurality of groves formed at the plurality of corners and circumferentially spaced around the longitudinal axis. Each of the grooves includes a flat surface.

In another independent aspect, the invention provides a tool bit including a working end, a shank extending from the working end and defining a longitudinal axis, and a drive portion including a plurality of corners, the drive portion being configured to be engaged by a tool. The drive portion includes a plurality of grooves formed at the plurality of corners and circumferentially spaced around the longitudinal axis. The drive portion includes a plurality of auxiliary grooves between the plurality of grooves.

Other aspects of the invention will become apparent by consideration of the detailed description and accompanying drawings.

### BRIEF DESCRIPTION OF THE DRAWINGS

FIG. 1 is a perspective view of a tool bit in accordance with an embodiment of the invention.

FIG. 2 is a side view of the tool bit of FIG. 1.

FIG. 3 is a cross-sectional view of a drive portion of the tool bit of FIG. 1 taken along section line 3-3 in FIG. 2.

FIG. 4 is a side view of a drive portion of a tool bit in accordance with another embodiment of the invention.

FIG. 5 is a cross-sectional view of the drive portion of the tool bit of FIG. 4 taken along section line 5-5 in FIG. 4.

FIG. 6 is a side view of a drive portion of a tool bit in accordance with another embodiment of the invention.

FIG. 7 is a cross-sectional view of the drive portion of the tool bit of FIG. 6 taken along section line 7-7 in FIG. 6.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

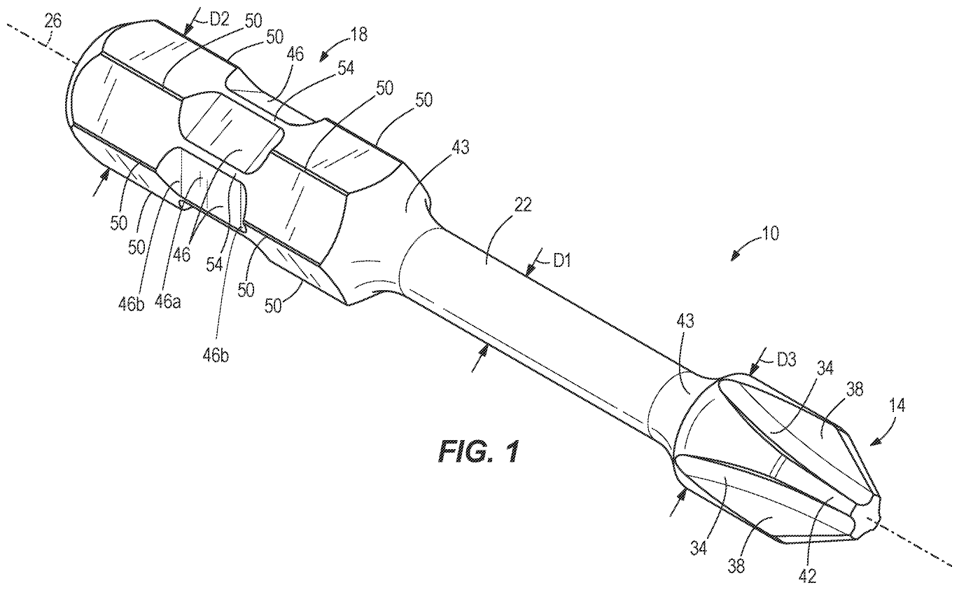

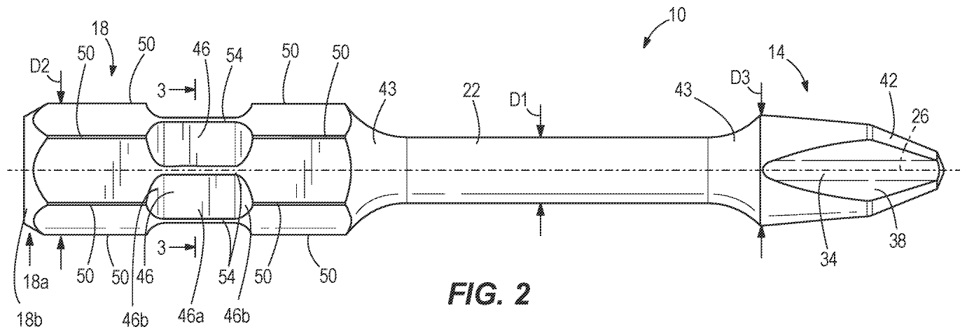

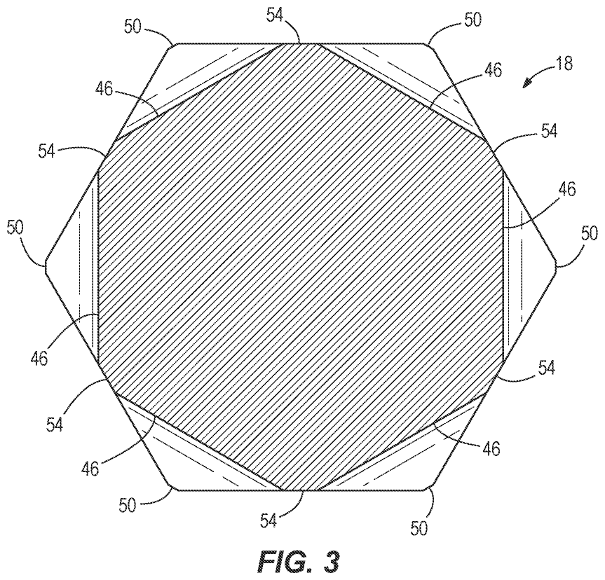

FIGS. 1-3 illustrate a tool bit 10 including a tip 14 (i.e., a “working end”), a drive portion 18, and a shank 22 interconnecting the tip 14 and the drive portion 18. The tool bit 10 also includes a central longitudinal axis 26 extending through the tip 14, the shank 22, and the drive portion 18. In the illustrated embodiment, the longitudinal axis 26 is defined by the shank 22. The central longitudinal axis 26 defines a rotational axis of the tool bit 10. In the illustrated embodiment, the tool bit 10 is a driver bit. In other embodiments, the tool bit may be other suitable types of bits. For example, the tool bit may be a drill bit, such as a twist drill bit, a step drill bit, an auger bit, a spade bit, and the like. The tool bit 10 may also be another type of bit with a hexagonal drive portion 18 or may be part of a tool having a hexagonal drive portion 18 (e.g., a socket adapter, a hole saw arbor, a driver sleeve, etc.). In the illustrated embodiment of FIG. 2, the drive portion 18 includes a distal end 18a spaced from the tip 14 with a chamfer. 18b

With reference to FIGS. 1-2, the tip 14 is coupled to an end of the shank 22 opposite from the drive portion 18. In the illustrated embodiment, the tip 14 is integrally formed with the shank 22, but may alternatively be a separate piece that is permanently secured to the shank 22. The tip 14 provides a working end or head for the bit 10 and is configured to engage a fastener (e.g., a screw). In the illustrated embodiment, the tip 14 is configured as a Philips-style tip. Alternatively, the tip 14 may have other configurations to engage different styles of fasteners. For example, the tip 14 may be configured as a straight blade (otherwise known as a “regular head”) to engage fasteners having a corresponding straight slot. Other tip configurations (e.g., hexagonal, star, square, etc.) may also be employed with the bit 10.

The tip 14 includes a plurality of flutes 30, or recesses, circumferentially spaced around the tip 14. The illustrated flutes 30 are equidistantly disposed about the longitudinal axis 26. The flutes 30 extend longitudinally along the tip 14 and converge into vanes 34. The vanes 34 are formed with flat, tapered side walls 38 and outer walls 42, such that the outer walls 42 are inclined and form the front ends of the vanes 34. The vanes 34 are also equidistantly disposed around the tip 14. In the illustrated embodiment, the vanes 34 gradually increase in thickness towards the shank 22. The illustrated flutes 30 are defined by a single, curved surface having a radius of curvature. The radius of curvature is continuous between adjacent vanes 34.

The shank 22 extends between the tip 14 and the drive portion 18. In the illustrated embodiment, the shank 22 is also integrally formed with the drive portion 18, but may alternatively be a separate piece that is permanently secured to the drive portion 18. The illustrated shank 22 has a reduced diameter, or dimension, D1 (i.e., a “first outer dimension”) compared to the remainder of the bit 10. More particularly, the reduced diameter D1 is an outer diameter of the shank 22, which is smaller than a maximum outer diameter, or dimension, D2 (i.e., a “second outer dimension”) of the drive portion 18 and a maximum outer diameter, or dimension, D3 (i.e., a “third outer dimension”) of the tip 14. The shank 22 further includes a fillet 43 at either end, transitioning to the larger diameter tip 14 and drive portion 18. The fillets 43 are contiguous with the tip 14 and the drive portion 18. In addition, each fillet 43 has a generally constant radius of curvature between the shank 22 and the tip 14 or the drive portion 18. In other embodiments, the shank 22 may have generally the same diameter as the drive portion 18 and/or the tip 14. The shank 22 may also be various lengths.

The drive portion 18 is configured to be engaged by any number of different tools, adapters, or components to receive torque from the tool, adapter, or component to rotate the tool bit 10. For example, the tool bit 10 may be used with a drill driver, impact driver, or hammer drill having a chuck that receives the drive portion 18. Alternatively, the tool bit 10 may be used with a hand tool having a socket or other suitable structure that receives the drive portion 18. The tool may include a quick release structure (e.g., a ball detent) that engages a circumferential power groove in a conventional hex-shaped drive portion 18.

As shown in FIGS. 1-3, the drive portion 18 of the tool bit 10 has a hexagonal cross-section. Other cross-sections of the drive portions 18 may be possible. For example, other polygonal cross-sections such as rectangular or pentagonal cross sections may be adequate. The illustrated drive portion 18 includes a plurality of grooves 46. The grooves 46 extend axially parallel to the longitudinal axis 26. In the illustrated embodiment, the grooves 46 extend along only an axial segment of the drive portion 18 (i.e., not the entirety of the drive portion 18). The grooves 46 are formed at corners 50 of the hex-shaped drive portion. The grooves 46 are radially aligned with the corners 50. The grooves 46 are also discrete grooves wherein each of the grooves 46 is distinct and separate from adjacent grooves 46 formed at adjacent corners 50. The grooves 46 are circumferentially spaced on the drive portion 18 about the longitudinal axis 26. In the illustrated embodiments, the grooves 46 are equidistantly spaced around the drive portion 18. In other embodiments, the grooves 46 may be unequally spaced. The illustrated grooves 46 are defined by planar or flat surfaces (i.e., a flat surface 46a) in the drive portion 18. The flat surface 46a is offset from and perpendicular to the longitudinal axis 26. The grooves 46 may be provided with a fillet 46b at opposite axial ends of the groove 46 to transition between the corner 50 and the groove 46. The illustrated grooves 46 are also generally rectangular. In other embodiments, the grooves 46 may be defined by curved or contoured surfaces and/or may have other shapes. In the illustrated embodiment, the drive portion 18 includes six grooves 46. In other embodiments, the drive portion 18 may include fewer or more grooves 46. The grooves are shaped and sized to receive a quick-release structure (e.g., a ball detent) of a tool to axially secure the tool bit 10 to the tool.

In the illustrated embodiment, the drive portion 18 also includes a plurality of flats 54. The flats 54 are raised segments, or areas, positioned between adjacent grooves 46. The flats 54, thereby, separate the grooves 46 into discrete grooves. In the illustrated embodiment, each of the flats 54 has an outermost surface that is coplanar with the hex-shaped cross-section of the drive portion 18. More specifically, the flats 54 are contiguous with the hex-shaped cross-section of the drive portion 18. In some embodiments, the flats 54 may be non-contiguous with the hex-shaped cross-section (e.g., the flats 54 may be slightly recessed or slightly raised relative to the hex-shaped cross-section). In the illustrated embodiments, the drive portion 18 includes six flats 54. In other embodiments, the drive portion 18 may include fewer or additional flats 54, depending on the number of grooves 46. In some embodiments, the flats 54 may only be positioned between some of the adjacent grooves 46.

The grooves 46 increase a cross-sectional area of the drive portion 18 compared to a drive portion with a conventional circumferential power groove. The larger cross-sectional area provides more resistance to shear/twisting stress, thereby increasing the life of the tool bit, while still allowing space to be engaged by a quick-release structure (e.g., a ball detent). In some embodiments, the drive portion 18 with grooves 46 may realize around 50% less stress when compared to a drive portion with a conventional circumferential power groove.

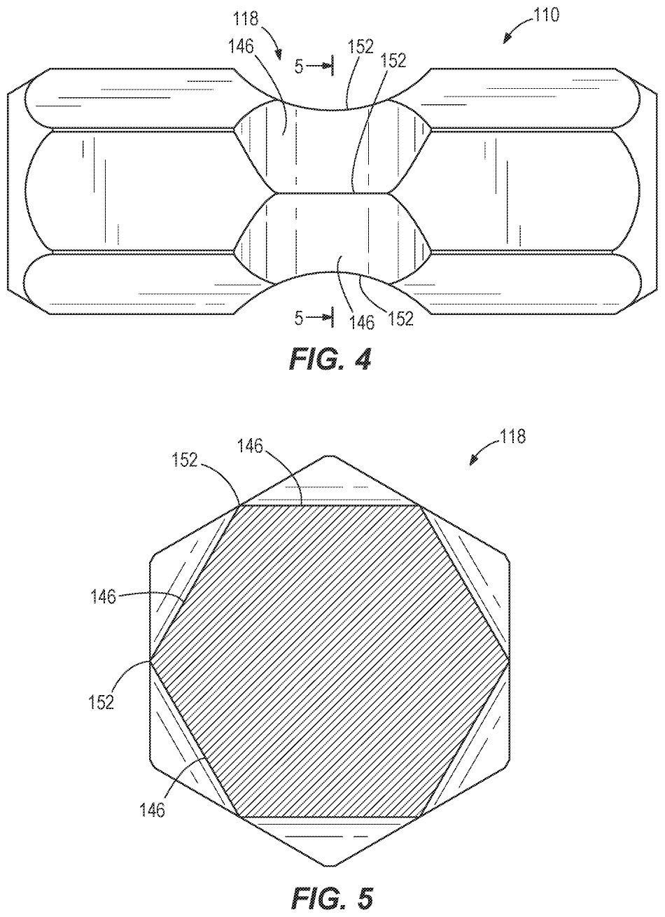

FIGS. 4-5 illustrate a drive portion 118 of another tool bit 110. The drive portion 118 is similar to the drive portion 18 described above, but does not include the flats 54 between adjacent grooves 46. Rather, the illustrated drive portion 118 includes a plurality of grooves 146 that are separated by edges or corners 152. In this embodiment, each of the plurality of grooves 146 abuts an adjacent groove 146. In the illustrated embodiment, the grooves 146 are also defined by rounded surfaces in the drive portion 118. Incorporating the flats 54 (e.g. FIG. 2) between adjacent grooves 46 provides improved performance (e.g., resistance to stress) compared to the grooves 146 without flats.

The grooves 146 may be formed by removing material from the drive portion 118 of the tool bit 110. In forming the grooves 146, a circular cutter may be revolved around the drive portion 118 to form the grooves 146. The resultant grooves 146 are concave in shape. The circular cutter forms the grooves 146 such that they are defined by a single curved surface having a common radius of curvature.

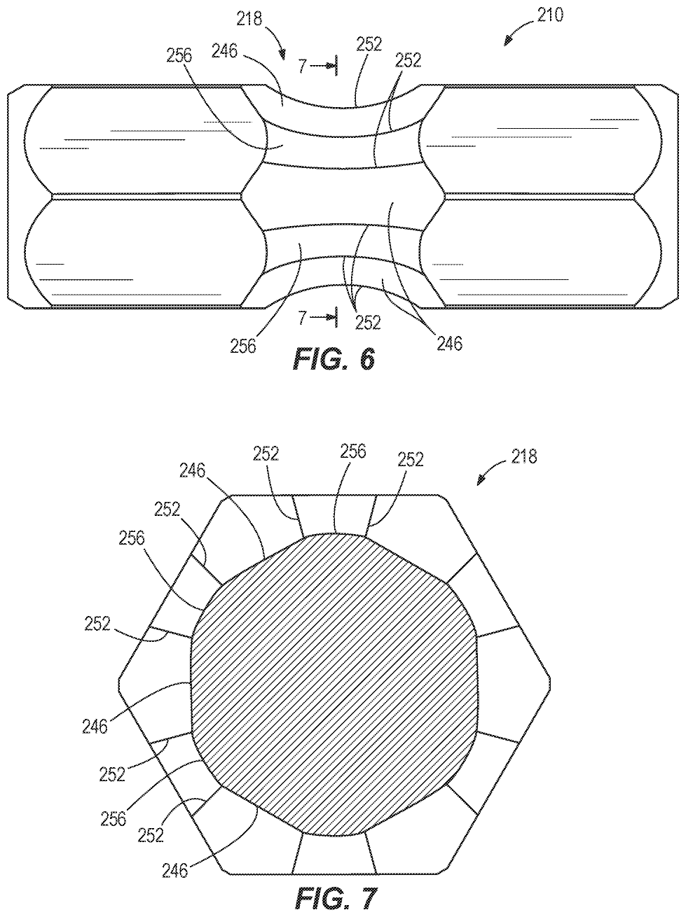

FIGS. 6-7 illustrate a drive portion 218 of another tool bit 210. The tool bit 210 includes similar features as the tool bit 110 with reference numerals shifted up by “100.” The drive portion 218 is similar to the drive portion 118 described above, but does have adjacent grooves 146 contacting each other directly. Rather, the illustrated drive portion 218 includes primary grooves 246 and auxiliary grooves 256 which separate adjacent primary grooves 246 from each other. Edges or corners 252 are located between each of the auxiliary grooves 256 and the adjacent primary grooves 246. The auxiliary grooves 256 may also be generally concave in shape.

The auxiliary grooves 256 may be formed by removing material from the drive portion 118 of the tool bit 110 to form the drive portion 218 of the tool bit 210. In forming the auxiliary grooves 256, a circular cutter may be revolved at a slightly offset position from the cutting position which formed the grooves 146 in the drive portion 118. As such, the auxiliary grooves 256 and the grooves 246 differ in depth from the exterior of the drive portion 218. In the illustrated embodiment, the auxiliary grooves 256 are shallower in depth when compared to the grooves 246. A deepest portion of the auxiliary grooves 256 is positioned between the adjacent corners 50. Whereas, a deepest portion of the groove 46 and the grooves 146 pass through the corners 50. The auxiliary grooves 256 are circumferentially spaced around the longitudinal axis between the grooves.

The tool bit 210 has improved functionality when compared to known tool bits.

The inclusion of the auxiliary grooves 256 permits the tool bit 210 to function with impact drivers which include ball detents located to correspond with flat surfaces between the corners 50 of their impact driver anvils. The revolved cut auxiliary grooves 256 allow for more clearance when the tool bit 210 is installed in such impact drivers. The auxiliary grooves 256 may provide substantially flat surfaces operable to receive ball detents of the impact driver anvils. The tool bit 210 is higher in resistance to stress than known tool bits. For example, the illustrated tool bit 210 shows about 5% less stress than current tool bits not including the primary grooves 246 and the auxiliary grooves 256.

Although the invention has been described in detail with reference to certain preferred embodiments, variations and modifications exist within the scope and spirit of one or more independent aspects of the invention as described.

Various features and advantages of the invention are set forth in the following claims.

1. A tool bit comprising:
a working end;
a shank extending from the working end and defining a longitudinal axis; and
a drive portion coupled to an end of the shank opposite from the working end, the drive portion including a plurality of corners, the drive portion being configured to be engaged by a tool;
wherein the drive portion includes a plurality of grooves formed at the plurality of corners and circumferentially spaced around the longitudinal axis.

2. The tool bit of claim 1, wherein the grooves extend axially parallel to the longitudinal axis along the drive portion.

3. The tool bit of claim 2, wherein the grooves extend axially parallel to the longitudinal axis along an axial segment of the drive portion.

4. The tool bit of claim 1, wherein the plurality of grooves are evenly circumferentially spaced around the longitudinal axis.

5. The tool bit of claim 1, wherein the drive portion includes a distal end spaced from the working end, the distal end having a chamfer.

6. The tool bit of claim 1, wherein the plurality of grooves intersect each other at edges such that each of the plurality of grooves abuts at least one adjacent groove.

7. The tool bit of claim 1, wherein the drive portion includes a plurality of flats, and wherein one of the plurality of flats is positioned between each pair of adjacent grooves.

8. The tool bit of claim 1, wherein the drive portion has a hexagonal cross-section with respect to the longitudinal axis.

9. A tool bit comprising:
a working end;
a shank extending from the working end and defining a longitudinal axis; and
a drive portion coupled to an end of the shank opposite from the working end, the drive portion including a plurality of corners, the drive portion being configured to be engaged by a tool;
wherein the drive portion includes a plurality of grooves formed at the plurality of corners and circumferentially spaced around the longitudinal axis, and
wherein each of the grooves is defined by a flat surface.

10. The tool bit of claim 9, wherein the flat surface is offset from and perpendicular to the longitudinal axis.

11. The tool bit of claim 9, wherein the drive portion is provided with a fillet at an axial end of each groove to transition between a corresponding corner of the plurality of corners and the groove.

12. The tool bit of claim 9, wherein the drive portion includes a plurality of flats, and wherein one of the plurality of flats is positioned between each pair of adjacent grooves.

13. The tool bit of claim 12, wherein the plurality of flats separate the plurality of grooves into discrete grooves.

14. A tool bit comprising:
a working end;
a shank extending from the working end and defining a longitudinal axis; and
a drive portion coupled to an end of the shank opposite from the working end, the drive portion including a plurality of corners, the drive portion being configured to be engaged by a tool;
wherein the drive portion includes a plurality of primary grooves formed at the plurality of corners and circumferentially spaced around the longitudinal axis, and a plurality of auxiliary grooves between the plurality of grooves.

15. The tool bit of claim 14, wherein the plurality of auxiliary grooves define edges located between each of the plurality of auxiliary grooves and adjacent primary grooves.

16. The tool bit of claim 14, wherein the plurality of auxiliary grooves differ in depth from the plurality of primary grooves.

17. The tool bit of claim 16, wherein the plurality of auxiliary grooves are shallower in depth than the plurality of primary grooves.

18. The tool bit of claim 14, wherein the plurality of primary grooves and the plurality of auxiliary grooves are both concave in shape.

19. The tool bit of claim 14, wherein the plurality of auxiliary grooves are circumferentially spaced around the longitudinal axis between the plurality of primary grooves.
